(19) United States
(12) Patent Application Publication
(10) Pub. No.: US 2005/0246293 A1
(43) Pub. Date: Nov. 3, 2005

(54) Electronic transfer system

(76) Inventor: Yong Kin (Michael) Ong, City Beach (AU)

Correspondence Address: NEEDLE & ROSENBERG, P.C., SUITE 1000, 999 PEACHTREE STREET, ATLANTA, GA, 30309-3915, US

(21) Appl. No.: 10/506,739

(22) PCT Filed: Feb. 28, 2003
(86) PCT No.: PCT/AU03/00255

§ 371 Date: Apr. 14, 2005

(30) Foreign Application Priority Data
Mar. 4, 2002 (AU) PS 0876

(51) Int. Cl. H04K 1/00; G06F 17/60

(52) U.S. Cl. 705/70

(57) ABSTRACT

A method of conducting an on-line transaction includes providing a transaction manager (12). Generating a single use transaction request identification, the transaction manager relating the transaction request identification to banking information of a registered user. Providing the registered user with the transaction request identification; the registered user requesting to purchase a product or service having a value from a merchant, the purchase request including providing the transaction request identification to the merchant. The merchant sending a payment request to the transaction manager for a fund transfer of the value from the user to the merchant, the payment request including the transaction request identification and the value; the transaction manager checking the validity of the transaction request identification and disabling re-use of the transaction request identification; and if the transaction request identification is valid, sending an EFT request to a financial institution to transfer the value in funds from the user to the merchant, the EFT request including the banking information; checking whether sufficient funds are present in the user's bank account and if sufficient funds are present, the financial institution performing the transfer according to the banking information; and the transaction manager receiving confirmation of the transfer from the financial institution and sending the confirmation to the merchant.

### FIELD OF THE INVENTION

The present invention is an electronic transfer system and method for conducting on-line purchases.

### BACKGROUND OF THE INVENTION

Present e-commerce transaction systems provide many consumers with insufficient confidence to shop on-line. Consumers are concerned about security issues in using their credit card or debit card to make purchases. They are concerned that should their credit card information fall into the wrong hands, the credit card owner may be liable for transactions they did not conduct nor authorise.

The electronic fund transfer (EFT) method described in the specification accompanying the international application PCT/AU01/00137 provides a process that adds security to the transaction.

The present invention relates to further improvements on this method.

### SUMMARY OF THE INVENTION

In accordance with the present invention there is provided a method of conducting an on-line transaction including the steps of:
providing a transaction manager,
generating a single use transaction request identification;
the transaction manager relating the transaction request identification to banking information of a registered user;
providing the registered user with the transaction request identification;
the registered user requesting to purchase a product or service having a value from a merchant, the purchase request including providing the transaction request identification to the merchant;
the merchant sending a payment request to the transaction manager for a fund transfer of the value from the user to the merchant, the payment request including the transaction request identification and the value;
the transaction manager checking the validity of the transaction request identification and disabling re-use of the transaction request identification;
if the transaction request identification is valid, sending an EFT request to a financial institution to transfer the value in funds from the user to the merchant, the EFT request including the banking information;
checking whether sufficient funds are present in the user's bank account and if sufficient funds are present, the financial institution performing the transfer according to the banking information; and
the transaction manager receiving confirmation of the transfer from the financial institution and sending the confirmation to the merchant.

Preferably the transaction manager generates the transaction request identification. In one embodiment the transaction request identification includes a random number. In another embodiment the transaction request identification is generated using a formula. In yet another embodiment the transaction request identification is generated using a random number and a formula.

Preferably a combined transaction identification is generated by hatching the transaction manager generated transaction request identification and a user supplied identification code, the combined transaction identification being send in the purchase request to the transaction manager.

Preferably the banking information related to the transaction request identification includes a credit card or debit card number, a card expiry date, a personal identification number (PIN) or password and a cardholder name. Alternatively the banking information includes a bank account number. It may additionally include bank account type and bank account holder information.

Preferably registration of the user occurs prior to the generation of the transaction identification. Preferably registration of the user entails creation of a transaction manager user account, wherein the transaction manager user account includes a transaction manager account number, and the banking information is provided by the user to the transaction manager. Preferably the transaction manager confirms the banking information with the user's financial institution. Preferably registration of the user includes the user providing the transaction manager with the user supplied identification code. Preferably the transaction manager records further user information, such as personal details in the user's transaction manager account.

Preferably the transaction request identification is related to the user's transaction manager account thereby linking the transaction request identification to the banking information. Preferably the user's transaction manager account information includes a transaction manager account expiry date, and a transaction manager account password. Preferably the transaction manager account information further includes a transaction manager account alias. Preferably each relationship of a transaction request account identification to the banking information further includes a transaction manager account number or transaction account alias, transaction limit, and a transaction limit override password.

Preferably the registered user is provided with another single use transaction request identification by the transaction manager upon request by the registered user.

Preferably the merchant is registered with the transaction manager. Preferably registration of the merchant entails the transaction manager providing the merchant with a merchant identification. Preferably the purchase request sent by the merchant to the transaction manager includes the merchant identification. Preferably the purchase request includes the combined transaction identification, wherein the merchant is provided with the transaction request identification in the form of the combination transaction identification.

Preferably the purchase request includes providing the merchant with the value of the purchase. Alternatively the user nominates the purchase item and the merchant provides the purchase value.

Preferably the transaction manager validates the transaction request identification by checking that the transaction request identification is related to the user's transaction manager account. Preferably the transaction manager account password is provided to authenticate the identity of the user providing the transaction request identification. Preferably disabling of the use of the transaction request identification is conducted by removing the relationship between the transaction request identification and the user's transaction manager account number. Alternatively, the transaction request identification is deleted from the user's transaction manager account information.

Preferably disabling use of the transaction request identification includes the step of adding the transaction request identification to a spent list, the spent list being used to ensure a transaction request identification is not reused.

In one embodiment the step of disabling re-use of the transaction request identification includes the formula for generating the single use transaction request identification including an increment in the next transaction identification request issued. Preferably the method of generating the transaction identification includes providing a check sum digit or character in the transaction request identification. Preferably the transaction request identification is a number.

Preferably the EFT request to the financial institution is conducted using the credit card or bank account details, the transfer amount (value of the transfer) and the merchant account details sent to the financial institution to transfer the funds according to a standard electronic fund transfer system.

Preferably the financial institution sends an insufficient funds reply if sufficient funds are not present, whereupon the transaction manager sends an insufficient funds reply to the merchant.

In one embodiment the confirmation of the transfer sent from the financial institution to the transfer manager is the same as the confirmation message sent from the transaction manager to the merchant. In another embodiment the transaction manager creates a different confirmation message for the merchant.

Preferably confirmation of transfer of funds is sent from the merchant or transaction manager to the user. Preferably this confirmation is sent in the form of an e-mail message.

Preferably the transaction request identification is issued to the user in an on-line environment, such as via the Internet. Alternatively the transaction request identification is provided to the user by a telephone interface system. Alternatively the transaction identification is issued to the user by sending the transaction identification to a portable storage device held by the user. Preferably the user can activate transfer of the transaction request identification from the portable device to the merchant. Preferably the portable storage device can store a plurality of transaction request identifications.

Preferably a plurality of transaction request identifications may be provided to the user. Preferably the transaction manager manages a plurality of registered users each having a plurality of transaction request identifications available for use in making a purchase.

Preferably the transaction manager registers a plurality of merchants. Preferably the transaction manager can conduct electronic transfers between a plurality of financial institutions.

Preferably the transaction request identification is a string of characters. Preferably the transaction request identification is a randomly generated string of characters.

According to another aspect of the invention there is provided a method of conducting an on-line financial transaction comprising the steps of:
registering a user with a transaction manager;
providing the user with a transaction identification code;
identifying the user to the transaction manager by the user providing the identification code to the transaction manager for verification, and when verified providing the user with a single use transaction code;
requesting a financial transaction including the user providing the transaction code; and
verifying the identity of the user from the transaction code, and when verified authorising the financial transaction.

Preferably the identification code comprises a login code and a password. Preferably the identification code is associated with banking information of the user, which is stored by the transaction manager.

Preferably the transaction code is generated by the transaction manager. Preferably the transaction code is related to the identification code.

Preferably the user requests the transaction from a third party. Preferably he third party is a merchant. Preferably the transaction is for the purchase of a good or service from the merchant. Alternatively the third party is a financial institution.

Preferably the user provides the third party with the transaction code as a part of the request. Preferably the transaction code is provided to the transaction manager by the third party. Preferably the value of the financial transaction is provided to the transaction manager by the third party.

Preferably if the financial transaction is authorised an Electronic Funds Transfer (EFT) request is sent to a financial institution according to the banking information stored by the transaction manager. Preferably the EFT request is for the transfer of the value of the transaction from the user according to the user's banking information to the third party. Preferably a check is performed prior to authorising the transaction as to whether the transaction is allowed to proceed. Preferably the transaction is allowed to proceed if sufficient funds are available to cover the amount of the transaction. Alternatively a check is performed as part of the EFT as to whether there are sufficient finds available to perform the EFT. Preferably the transaction manager is notified of the success of the BET.

Preferably the transaction manager provides a confirmation to the third party of success of the financial transaction.

Also in accordance with the present invention there is provided a method of conducting an on-line transaction including the steps of:
providing a transaction manager;
generating a single use transaction request identification;
the transaction manager relating the transaction request identification to banking information of a registered user;
providing the registered user with a transaction request identification;
the registered user requesting to transfer an amount from a user account to another account, the transfer request including providing the transaction request identification and amount to the transaction manager,
the transaction manager checking the validity of the transaction request identification and disabling re-use of the transaction request identification;
if the transaction identification is valid, sending an EFT request to a financial institution to transfer the amount of funds from the user's account to the other account, the EFT request including the banking information;
checking whether sufficient funds are in the user's bank account and if sufficient funds are present, the financial institution performing the transfer according to the banking information; and
the transaction manager receiving confirmation of the transfer from the financial institution and sending the confirmation to the user.

In accordance with the present invention there is provided a system for conducting an on-line transaction including:
means for a user to request transfer of a value of money to be transferred to a receiving party and providing a single use transaction request identification to a transaction manager in a payment request; and the transaction manager, which comprises:
means for registering the user;
means for registering a merchant;
means for generating the single use transaction request identification;
means for providing the registered user with the transaction request identification;
means arranged to relate the transaction request identification to banking information of the registered user;
means for receiving the payment request, the payment request including the transaction request identification, the value to be transferred and an identification of the receiving party;
means for checking the validity of the transaction request identification and disabling re-use of the transaction request identification;
means for sending an EFT request to a financial institution to transfer the value in funds from the user to the receiving party, if the transaction request identification is valid, the EFT request including the banking information; and
means for receiving confirmation of the transfer from the financial institution and sending the confirmation to the user and/or the receiving party.

According to another aspect of the present invention there is provided a transaction manager for conducting an online transaction, comprising:
means for registering a user and receiving banking information from the user, means for registering a merchant;
means for receiving a request from a user for a single use transaction request identification for making a purchase;
means for generating the single use transaction request identification;
means for checking the validity of the user, providing the user with the transaction request identification to the banking information of the user if the user is valid, and relating the transaction request identification;
means for receiving the transaction request identifier and a value of a purchase from the merchant in a purchase report, the transaction request identification having been provided by the user to the merchant in the course of requesting a transaction for the purchase;
sending an EFT request to a financial institution to transfer the value in funds from the user to the merchant, the EFT request including the banking information, if the transaction request identification is valid; and
means for validating the transaction request identification, disabling re-use of the transaction request identification and means for providing the merchant with a unique transaction acceptance identifier if sufficient funds are present for the transfer to occur.

### BRIEF DESCRIPTION OF THE DRAWINGS

In order to provide a better understanding of the present invention, a detailed description will be provided of preferred embodiments of the present invention, in which:

FIG. 1 is a schematic representation of communication between participants of a transaction system of the present invention;

FIG. 2 shows a schematic diagram showing communication between a user and the transaction manager and an external organisation or institution in the process of setting up a transaction manager account for the user;

FIG. 3 is a schematic representation showing communication between a merchant and transaction manager in a process for a merchant to apply for a transaction manager account;

FIG. 4 is a schematic representation showing communication between a financial institution and a transaction manager in the setting up of an account with the transaction manager;

FIG. 5 is a schematic representation showing communication between a user and a merchant for the purchase of a product or service;

FIG. 6 is a schematic representation showing communication between a merchant and transaction manager in the purchase of a product or service;

FIG. 7 is a schematic representation showing communication between a transaction manager and a financial institution or bank in the purchase of a good or service;

FIG. 8 is a schematic representation showing communication between the transaction manager and the user and the merchant confirming payment of purchase;

FIG. 9 is a flow diagram showing steps involved in the application of an account with the transaction manager;

FIG. 10 is a flow diagram showing steps involved in the process of the user making a purchase;

FIG. 11 is a schematic representation showing communication between the user and a transaction manager in the user providing the transaction manager with a secure user identification code;

FIG. 12 is an example of hatching a user identification code into a transaction identification number to produce a combined transaction identifier;

FIG. 13 is another example of hatching a user identification code into a transaction identification number;

FIG. 14 shows more examples of hatching a user identification code into a transaction identification number;

FIG. 15 shows alternative methods of communication between a user and a transaction manager; and

FIG. 16 shows a schematic representation of the structure of the transaction manager of the present invention.

### DETAILED DESCRIPTION OF THE INVENTION

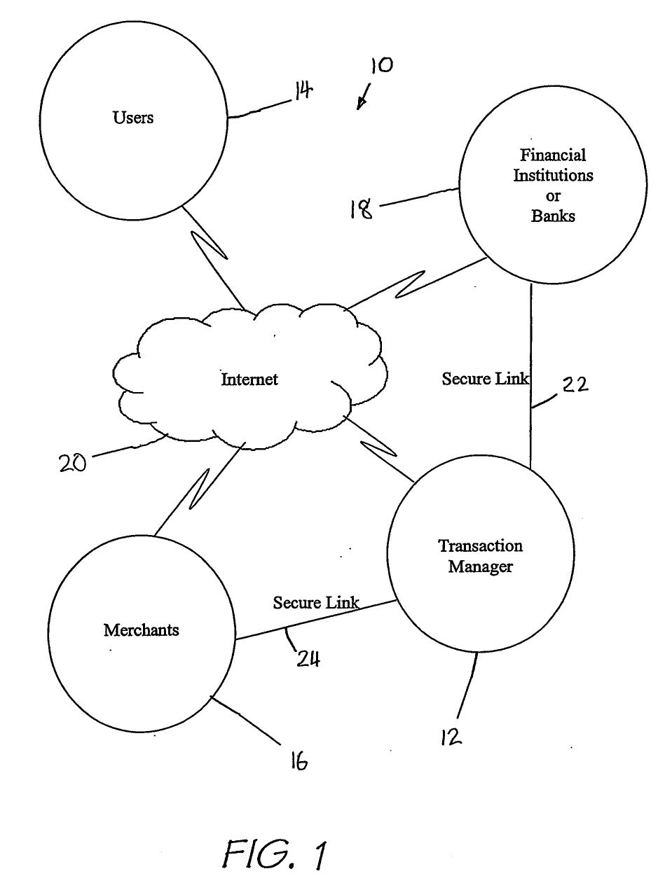

Referring to FIG. 1 there is shown a system for conducting financial transactions 10, which includes a transaction manager 12, which is a trusted intermediatory that provides services between users 14, e-commerce merchants 16 and financial institutions 18. In particular the transaction manager 12 is an intermediatory that each user can trust to conduct electronic transactions on behalf of the user.

Users 14 can communicate with a transaction manager 12 over the Internet 20 or another suitable network. Each merchant 16 communicates with the transaction manager 12 via a secure link 24. Each financial institution 18 communicates with the transaction manager 12 via a secure link 22. The secure links 22 and 24 may be point to point connections or encrypted communication over a public network, such as the Internet 20.

Each user 14 must register with the transaction manager 12, whereupon an account is created with the transaction manager 12. To register with the transaction manager 12 the user 14 must provide the their bank account details, along with some personal details. The bank account details may include bank account number, account type, credit card number, debit card number, expiry date of each card, and/or credit card limits. The personal details will include name and address, but also may include other details such as date of birth, social security number, drivers licence number, passport number, etc. The account type may be for example savings account, cheque account, credit card account, debit card account, interest saver account or other types of banking or financial institution account. Each user account created with the transaction manager is provided with a transaction manager account number.

Information held by the transaction manager 12 in relation to each user is held in confidence and in compliance with privacy laws.

In one embodiment the user also provides a security identification code which is used in the generation of a combined transaction identifier, as will be described below. This user identification code may be changed as desired by the user.

The transaction manager account number may be associated with a transaction manager account alias such as a name, for example “John Doe”. Each alias will need to be unique so that no two user aliases can be confused. The user 14 may use the alias to refer to the transaction manager account rather than the account number. The transaction manager account number is related or mapped to the bank account details including the user's bank account number or credit card/debit card number and kept secure. One of the key advantages of the present invention is that the user details including the user's bank account need not use the credit card number to conduct financial transactions. The alias can be used to login to the transaction manager to change details, provide a new user identification code, view past transactions or otherwise manage the user's account.

A transaction manager account expiry date is provided to the account, which is a date on which the transaction manager account will cease to be operational. The account may be renewed and the expiry date extended.

A transaction manager account password is an optional feature that may be included that provides an additional level of security before the transaction manager will process a transaction. This will be described in further detail below. Alternatively or in addition it may be used to login to the user's account with the transaction manager for account management purposes.

A plurality of transaction managers may be provided. A financial institution or other organisation may be licensed to operate a transaction manager. Transaction managers may be geographically located to support a particular region according to, for example a licensing agreement. Transaction managers may communicate with one another to process payments. Thus a single transaction manager account number can be used for any account of any financial institution registered with one of the transaction managers. Where there are a plurality of transaction managers they may operate as a single logical transaction manager 12.

Financial institution 18 may be for example a bank, a credit society, a credit union, building society or any other suitable form of financial institution which have accounts within which users can deposit money and the money being able to be electronically transferred from their account.

A merchant 16 is a person or entity that uses an on-line site, such as an Internet site, to do business with users 14. Merchants 16 register with the transaction manager 12 to use the facility provided by the present invention. The registration process ensures that an e-commerce merchant site is a secure site. Internet clients are assured of this certification by the transaction manager 12. The transaction manager 12 will maintain a database of registered e-commerce merchants 16. The e-commerce merchant 16 also requires a bank account with a financial institution 18 in order to receive payments. The transaction manager 12 as the intermediatory is trusted by the user to process payments from the user 14 and ensure they go to the correct merchant 16, only when appropriately authorised by the user 14.

Cooperation is required between the transaction manager 12 and the financial institution 18 of the user 14 to enable funds to be transferred at the direction of the transaction manager 12. The transaction manager account is issued to a customer on the basis of understanding between transaction manager 12 and the financial institution 18. The transaction manager 12 is responsible for security of business to user transactions.

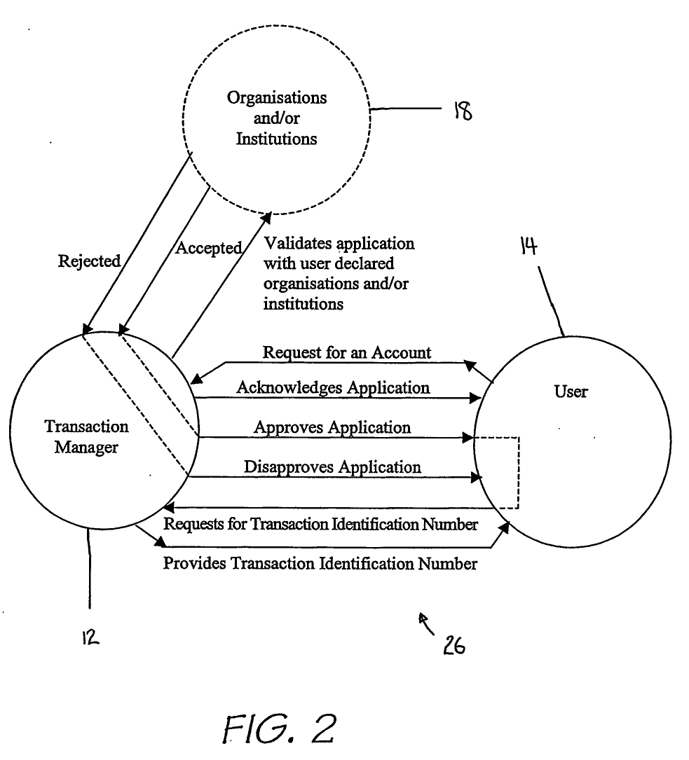

Referring to FIG. 2, there is shown a communication process 26 for the registration of a user 14 with the transaction manager 12. A user 14 sends a registration request to the transaction manager website and requests an account. Along with the request for the transaction manager account, necessary information for the transaction manager to create the account is sent to the transaction manager 12 (such as the personal details of the user and banking details of the user with their financial institution 18).

The transaction manager 12 acknowledges the application and provided the user 14 meets the transaction manager's criteria, requests that the financial institution 18 validate the application. Financial institution 18 either accepts or rejects the validation. The transaction manager 12 then either approves or disapproves of the application for registration and sends the appropriate response to the user 14.

A user 14 may have more than one financial institution account linked to the transaction manager account. In this case the user 14 provides all the banking information required for the additional accounts and the transaction manager 12 seeks validation with each financial institution. Typically one financial institution's account will be nominated as a primary account.

In order to undertake a financial transaction the user 14 must then request at least one transaction request identification, also referred to as a transaction identification number, transaction identification code or transaction identifier. The purpose of the transaction identifier includes identifying the user to the transaction manager on a transaction by transaction basis, as will be described in more detail below. The transaction identification number need not be strictly a number, it could be a character string, but will usually be converted into a binary number. The transaction identifier should be treated confidentially, like other passwords, until it is used.

For each transaction that the user 14 wishes to make a request must be made for a transaction identification number or a request for a plurality of transaction identification numbers must be made. The user 14 need not do this straight away. The user 14 may request additional transaction identification numbers at any time.

If the user has more than one financial institution account related to the transaction manager account, the financial institution account used in the transaction needs to be specified. This can occur at the time the transaction identification number is issued, so that the request for the transaction identification number includes nomination of the financial institution account. Thus use of the transaction identification number will result in the nominated financial institution account being used. However the preferred option is to allow the user to choose the account at the time of purchase. This method will be described in more detail below.

Prior to or when the user 14 decides to make a purchase, the user sends a request for one or more transaction identification numbers to the transaction manager 12. The transaction manager 12 then provides the requested number of transaction identification numbers to the user 14. A single transaction identification number is used for each purchase. It is provided to a merchant 16 usually by entering it in a checkout form of the merchant's website, but other methods may be employed, such as download from a personal device, such as a smart card, a Personal Digital Assistant, handheld computers mobile phone, etc. A transaction cannot take place until a transaction identification number is issued and has been given to the merchant.

The transaction identification number will be sent by the merchant 16 to the transaction manager 12. The transaction identification number is then used by the transaction manager 12 to identify the user 14 and thereby look up the user's account to obtain the necessary information to then conduct the financial transaction. The transaction identification number is a single use number given in confidence to the user 14. Once a transaction identification number is used it is not able to be used again. The association/mapping between the transaction identification number and the user's transaction manager account is made no longer active. The transaction identification number needs to be distinguished from a number that may be generated by for example an EFTPOS terminal for tracking financial transaction. It also needs to be distinguished from a credit card number that a user provides to a merchant which then can be re-used.

If the user has more than one financial institution account additional details may need to be entered to identify the account the user wishes to use. An example is below:

When the user 14 makes a purchase they enter:
Account number
Transaction ID
PIN
Account Type (for example 2 or more characters)

The account type code can be left null, or have 1 or 2 characters or more.

Codes are typically:
S=savings
C=cheque
H=homesaver
V=visa
A=american express
M=master card

Should they only have one nominated financial account they leave the account type null. Should the user 14 have more than one nominated financial institution account, they can leave Account Type null, in which case the transaction is assumed to be using their primary nominated financial institution account. be using their primary nominated financial institution account.

Should they have more than 1 nominated financial account, for example a savings and a visa, and they wanted to use their savings account they would enter S for the account type.

If they have more than 1 Visa card (credit card) or more than 1 savings account that has been specified as a nominated financial account the second account type character comes in. For example, if they want to use their 2^{nd} Visa card they would specify V2 for their account type.

Users need to be informed of their account type codes when the transaction manager account is approved or if the transaction manager account has been modified by adding an additional nominated financial institution account.

The transaction identification number can be a randomly generated number or it may be generated by a formula, such as a sequentially generated number. It may include a checksum or validation digit/s. Further, it may also be part random and part generated by a formula. The transaction identification number can also be included with the user identification code supplied by the user into a combined transaction identifier. The user identification code can be hatched into the random/formula generated portion according to a variety of layout structures.

A user identification code is a never transmitted together as a transaction identification number to a user 14. This ensures that a third party cannot intercept the user identification code. This enables the transaction manager to send the transaction identification numbers via the Internet, public networks and using SMS (short message service) or other message service.

When a user provides a transaction identification number to a merchant 16 for processing a transaction request, the user must provide the user identification code as the combined transaction identifier in the structured format determined by the transaction manager with the transaction identification number. Failing which the transaction will be rejected.

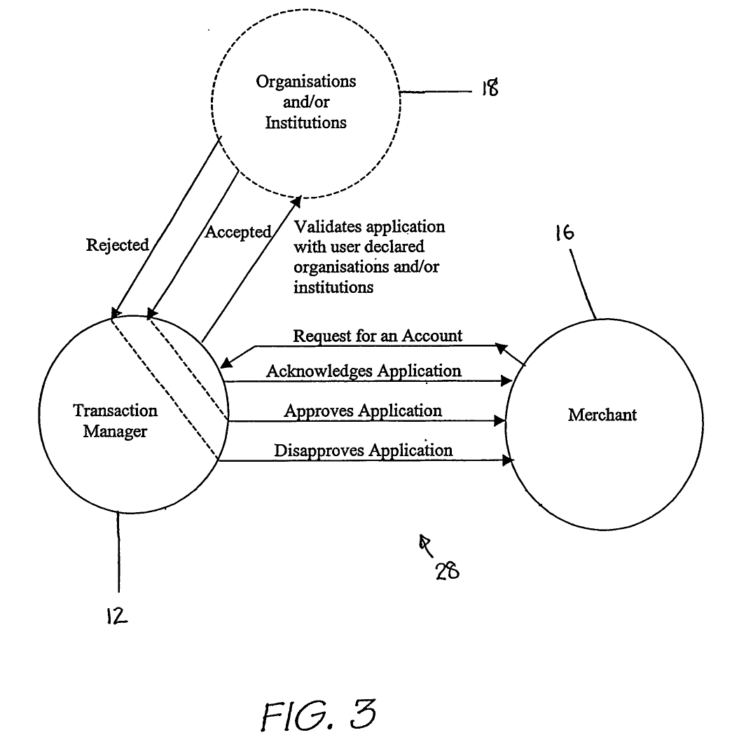

Referring to FIG. 3, a communication process 28 for a merchant 16 registering with the transaction manager 12 is shown. Merchant 16 offers its products or services on-line. For the merchant to use the present invention, the merchant must request an account with the transaction manager 12. A request along with the appropriate details of the merchant 16, including details of the bank account into which transfers are to be made are provided in a request to the transaction manager 12. The transaction manager 12 acknowledges the application. A check may be conducted or an undertaking given that the merchant 16 has a sufficiently secure website and other meets any other terms and conditions. After this, the transaction manager 12 requests validation of the merchant's banking details with the merchant's financial institution 18. The financial institution 18 either accepts or rejects the validation. The transaction manager will then in turn approve or disapprove the merchant's application. If the application is approved the merchant 16 will be provided with a merchant identification number. The merchant identification number is used to identify the merchant 16 to the transaction manager 12. The transaction manager 12 is then able to look up the banking details of the merchant so that the funds can be deposited in the merchant's bank account. The merchant identification will be included in communication between the merchant 18 and the transaction manager 12.

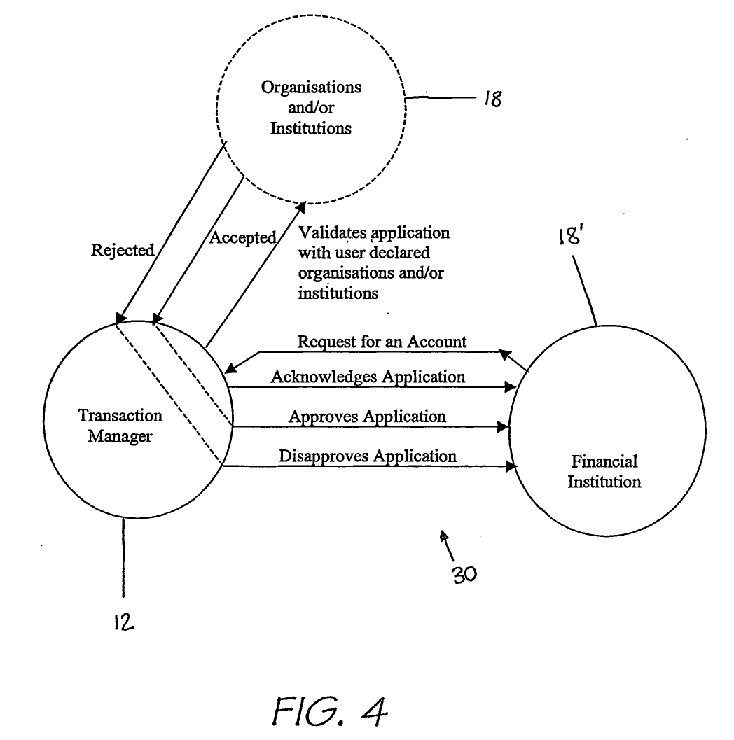

Referring to FIG. 4, the financial institution 18′ may also required to register with the transaction manager 12 in order to ensure that appropriate services are provided by the financial institution 18′ to conduct the present invention and as a security measure for identifying the financial institution 18′, thereby ensuring it is not a hacker. Registration is also requested of the financial institution 18′ in order to be licensed to operate as another transaction manager. The communication process here is shown as 30. The financial institution 18′ requests an account and provides details to the transaction manager 12. The transaction manager 12 acknowledges the application to the final institution and requests validation with other financial institutions or organisations 18. If the above organisations or institutions 18 accept or reject the application the transaction manager 12 then forwards an approval or disapproval of the application to the applicant financial institution 18′.

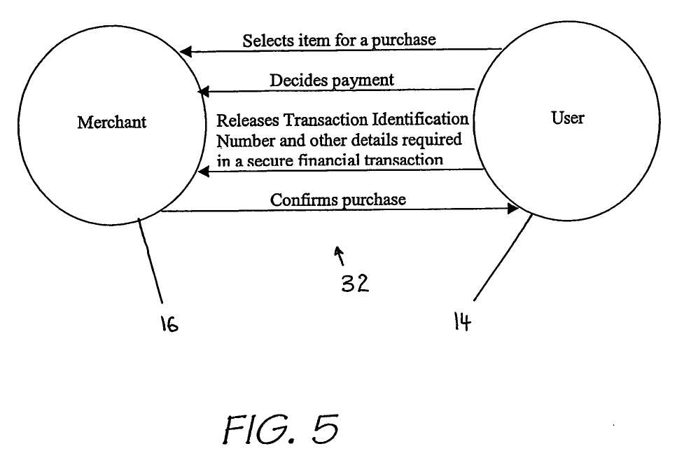

Referring to FIG. 5, after the user has obtained a transaction identification number the transaction manager 12 is then able to undertake communication process 32. The user selects an item for purchase from the merchant 16, such as by using an online shopping cart system. The user 12 decides to make a payment to the merchant and releases to the merchant the transaction identification number and other information required. Other information required may include selection of an account type, a password, transaction limit, an override password or other necessary information.

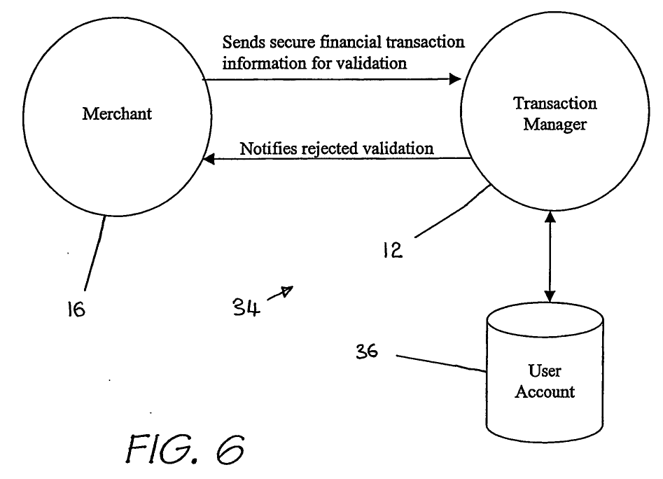

Referring then to FIG. 6, which shows communication process 34. The merchant 16 sends the transaction identification number and other details over the secure link 24 to the transaction manager 12. The transaction manager 12 checks whether the transaction identification is valid and associated with a user transaction manager account. The association is used to access the user's transaction manager account 36. Matching the transaction identification number with the user's account 36 enables the transaction manager 12 to look up and obtain the banking information in the user's account 36.

Re-use of the transaction request identification is disabled by: removing the relationship between the transaction request identification and the user's transaction manager account number; deleting the transaction request identification from the user's transaction manager account information; and or adding the used transaction request identification to a spent list. The spent list is used to ensure the used transaction request identification is not reused. Furthermore the formula for generating the single use transaction request identification may include an increment so that an unique transaction request identification is generated each time.

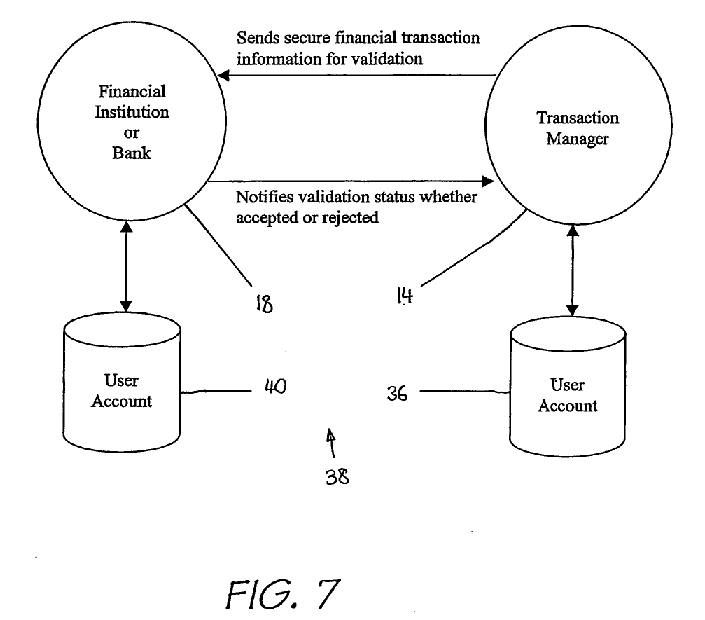

Referring to FIG. 7, which shows communication process 38. The banking information of the user is then sent in the form of secure financial information to the financial institution 18, including the bank account details/credit card details. The financial institution 18 then checks the user's financial account information/credit card number in the user's financial institution account 40 to confirm the validity of those details and check that sufficient finds are available in the user's bank account 40. The final institution 18 then notifies the transaction manager 12 of the validation status and whether it is accepted or rejected.

The amount is transferred from the user's account 40 to the merchant's account.

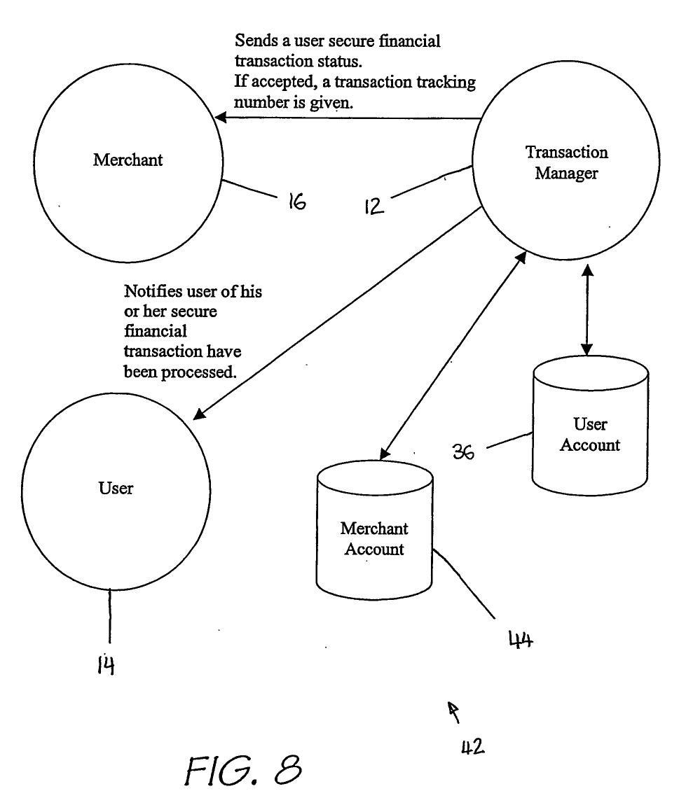

Referring to FIG. 8, which shows the communication process 42. The transaction manager 12 sends the merchant by secure link 24 the status of the transaction and whether it is accepted. If it is accepted a transaction tracking number is provided to the merchant 16. The transaction manager 12 also notifies the user 14 that the secure transaction has been processed. This may be by e-mail, for example. The transaction manager 12 also updates financial information in the merchant's transaction manager account 44, along with providing an audit trail, and updates the financial information in the user's transaction manager account 36, along with audit trail information.

Referring back to FIG. 5, the merchant 16 confirms that the purchase has occurred and then provides the goods or service to the user 14.

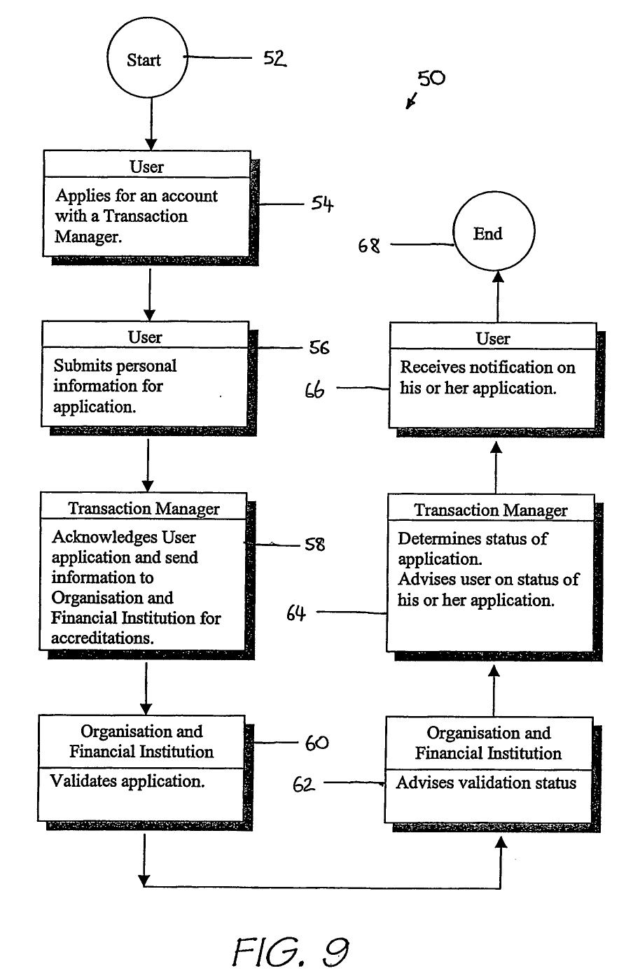

Referring to FIG. 9, flow diagram 50 shows steps for the user applying for an account with the transaction manager. The process starts at 52 with application for an account with the transaction manager being made by the user at 54. The user submits personal information for the application at 56 including banking details. At 58 the transaction manager acknowledges to the user the application and sends the information to the relevant organisation or financial institution for accreditations. Other organisations may include credit rating organisations.

At 60 the other organisation or financial institution validates information sent by the transaction manager. At 62 the other organisation or financial institution advises the transaction manager of the validation status. At 64 the transaction manager determines the status of the application according to the validation status from the organisation or financial institution and other criteria that may be applied by the transaction manager and advises the user of the status of his or her application. At 66 the user then receives notification of his or her application whereupon the process ends at 68.

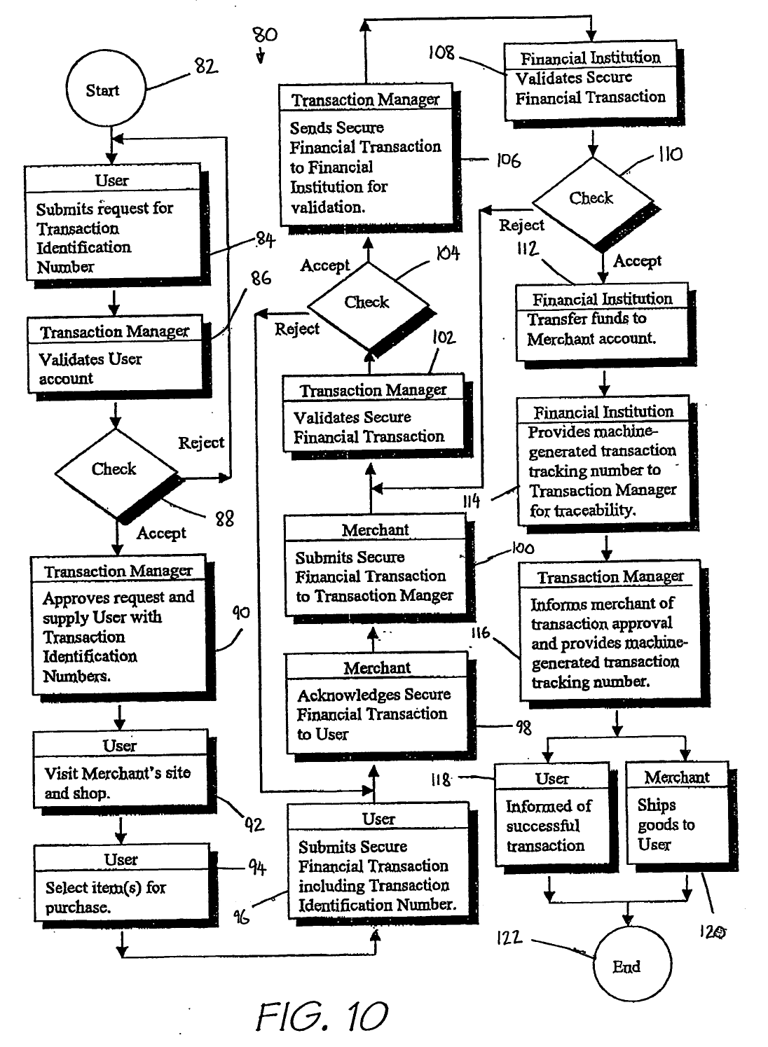

Referring to FIG. 10 a process 80 is shown with the user making a purchase payment for an item. The process starts at 82. At 84 the user submits a request for a transaction identification number to the transaction manager. At 86 the transaction manager receives the request for the transaction identification number and performs a validation of the user's account, including whether the user has an account and whether the account is active. The user making the request also provides either their account number or their account alias to the transaction manager to identify the user. The transaction manager account password may be required to authenticate the identity of the user. A check is performed at 88 of the validity of the user's account. If rejected the process returns to the start at 82. If accepted the process moves to 90. The transaction manager approves the request and supplies the user with one or more transaction identification numbers.

The transaction identification numbers may be provided on a screen for the user to print out if the request is conducted on-line or may be verbally provided to the user if the request is conducted over the telephone or they may be electronically transferred to a storage device for storing the transfer identification numbers. Further alternatives for delivering the transaction identification number/s include using the postal service to deliver a printed list of number/s or a card having a silver latex layer covering the number/s, which may be removed by scratching similar to instant lottery tickets.

The user may also request a limit be placed on transactions. A limit may be provided by default. The value of the limit may be modified by the user. If a transaction value is above the limit it will be rejected as explained in more detail below. The user may have a special reason for overriding the normal transaction limit. In this case an override password is stored in the user's transaction manager account. Overriding the limit is described below.

The user may then leave the transaction manager's website, hang up or disconnect the storage device.

At a later time the user may visit a merchant's electronic commerce shop site on-line at 92. The user selects an item for purchase from the merchant's website at 94. Selection of an item may indicate the price or the user may be required to enter the price in a checkout form. The entries into the checkout form are required by the transaction manager to be encrypted when sent between the merchant and the user's computer. The user enters one transaction identification number to the checkout form submitted to the merchant. This may be by typing in the number into a form or by a storage device entering the transaction identification number into the form or transferring it in some other suitable manner. If the value of the transaction will be above the transaction limit, the user may enter the override password. This information is sent by secure encrypted submission from the user to the merchant.

At 98 the merchant acknowledges the secure financial transaction to the user. At 100 the merchant then submits a secure financial transaction request to the transaction manager. This request will include the transaction identification number, the amount of the purchase, the merchant's identification and the override password, if applicable. At 102 the transaction manager validates the secure financial transaction request. If the value is over the transaction limit it will be rejected unless the override password is provided. The check is performed at 104, and if rejected such as by the transaction identification number not being valid or the merchant's identification not being valid, or the transaction value being over the limit, the process is returned to step 98. If accepted, at 106 the transaction manager looks up the user's transaction manager account to find the bank account details stored in the user's transaction manager account and looks up the merchant's banking details. These are then sent at 108 in an electronic fund transfer (EFT) request to the financial institution. The financial institution validates the financial transaction request at 110 and if the validation is rejected, returns a rejection message to the transaction manager which will then reject the transaction and return the process to 98. If the financial institution accepts the EFT request the process moves to 112 where the financial institution transfers funds from the user's account to the merchant's account according to the details provided by the transaction manager. The financial institution then provides a tracking number to the transaction manager at 114. At 116 the transaction manager then informs the merchant of the transaction approval and provides the tracking number to the merchant. At 118 the transaction manager informs the user of the successful transaction, preferably by e-mail. At 120 the merchants ships the goods to the user and in one embodiment also confirms with the user that the transaction has been completed. The process then ends at 122.

The merchant is able to access account history with the transaction manager by details stored in the merchant's transaction manager account 44. The user is also able to access transaction history from the user's transaction manager account 36.

The present invention may also be used to transfer money between two or more user accounts or a user account and other person's or entity's account. The recipient must be a transaction manager account holder. A fund transfer request can be initiated by a transaction manager account holder. The transaction manager receiving this fund transfer request will then relay this request to the relevant transaction manager within the transaction manager business network. This transaction manager will then process this fund transfer request and the recipient transaction manager account will be credited.

The present invention clearly provides an advantage in that the user is not providing their credit card or other details to the merchant. Instead, they are providing a transaction identification number which is a single use number. Furthermore, if the transaction requires an amount greater than the predefined limit applied to the transaction identification number/s but provided that the amount is within the limits of the user's credit limit with their financial institution the user may override the transaction limit by providing a password as part of the transaction process. In addition, the transaction manager operates as more than just a clearing house in that it is an organisation trusted by the user that conducts the electronic fund transfer with the financial institution.

The user identification code may be provided to the transaction manager by Internet, telephone or mobile telephone, SMS (short message service) by a mobile phone or Internet. The transaction identification number and/or the user identification code may include alphabetic characters as well as numeric characters. To provide alphabetic characters over a telephone, a normal process of numeric entry interpretated as a alphabetic entry can be employed. For example, entry of an asterisk (*) key prior to the number may indicate a number is converted to alphabetic. Generally, numbers are allocated with three or four letters on most modern numeric keypads. The number of asterisks entered prior to entry of the number can indicate the letter being entered. Similarly, a hash (#) key can be used instead of an asterisk key. Furthermore, lower case characters can be generated by, for example, using asterisk or hash key to convert between lower and upper case.

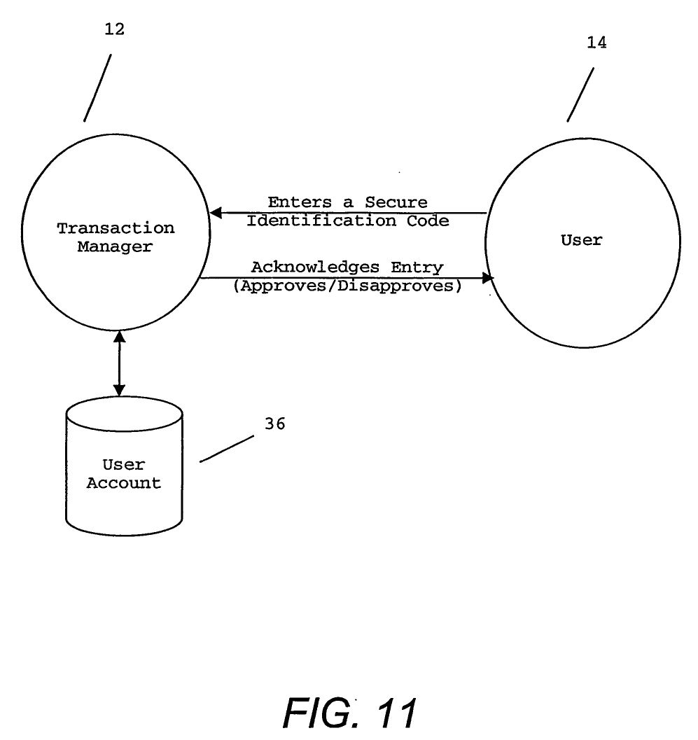

Referring to FIG. 11, communication between a user 14 and transaction manager 12 is shown. The user provides secure user 14 identification code to the transaction manager 12. The user 14 may do this via the transaction manager website or as mentioned above by telephone, SMS, etc. The message including the secure user identification code is sent from the user 14 to the transaction manger 12. The transaction manager 12 may required the identification code to have a minimum number of characters. If the identification code meets this criteria, an acknowledgment entry is sent from the transaction manager to the user approving or disproving of the identification code entered by the user. The identification code is stored in the user's account 36 with the transaction manager 12.

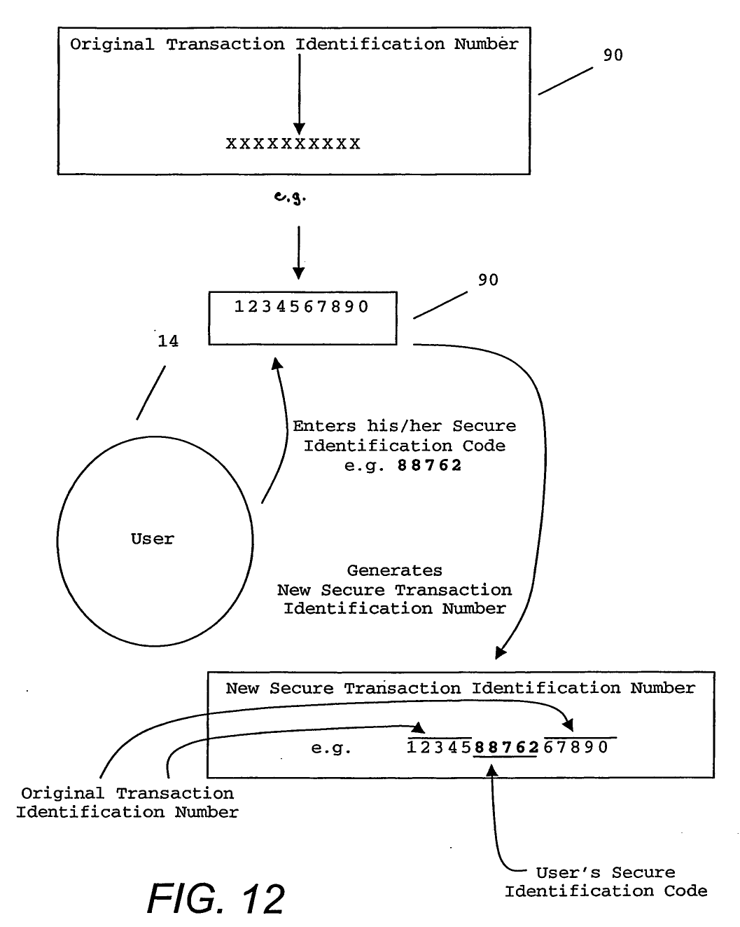

FIG. 12 shows an example of hatching of a secure user identification code into transaction identification number. This example transaction identification number is 1 2 3 4 5 6 7 8 9 0. The transaction identification number is identified as 90. When the user wishes to provide a transaction identification number to the merchant to conduct a transaction, the user provides their secure user identification code, in this case the example is 88762, which is then combined with the transaction number according to a predetermined rule, such as in the middle of the transaction identification number, to create a new combined identification number, which in this example is 123458876267890.

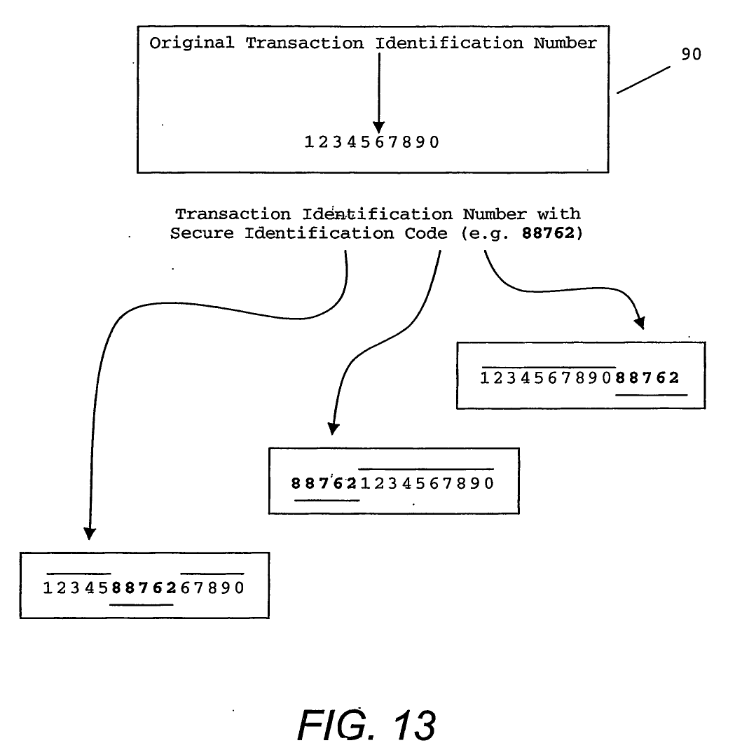

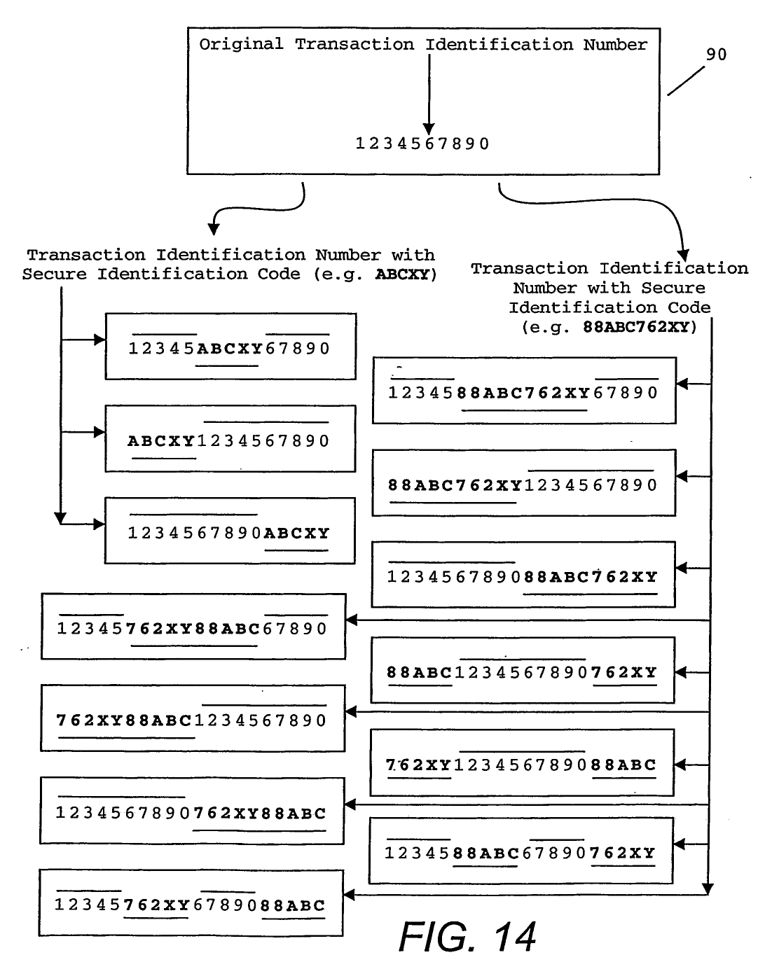

FIG. 13 shows some examples of alternative ways of combined transaction identifier with the secure user identification code being positioned in the middle, the beginning and the end of the original transaction identification number. FIG. 14 shows yet another example, in this case the user's secure identification code is alphabetic in the first three examples and the combination of numeric and alphabetic in the next ten examples. Some examples show the codes being placed in different positions, other examples show the codes being split in various positions. Numerous other variations will be evident to the skilled addressee.

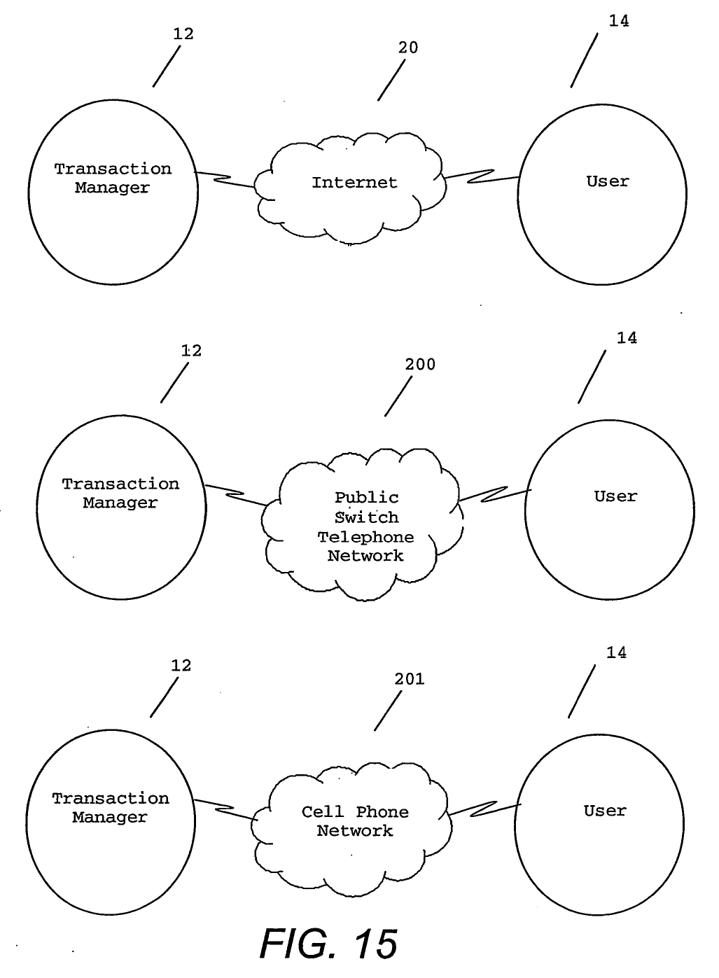

FIG. 15 shows alternative methods of communication between the user and the transaction manager by which the user can provide their secure identification code to the transaction manager or the transaction manger can provide a single user identification number to the user. In the first example, the Internet 20 is used, either via a website or by e-mail. In the second middle example, a public switch telephone network 200 is used so that a user may enter information used in the telephone keypad. The transaction manager may provide the user with information using computerised speech generation. In the third example, a mobile/cellular phone network 201 is used in a similar manner to the public switch telephone network.

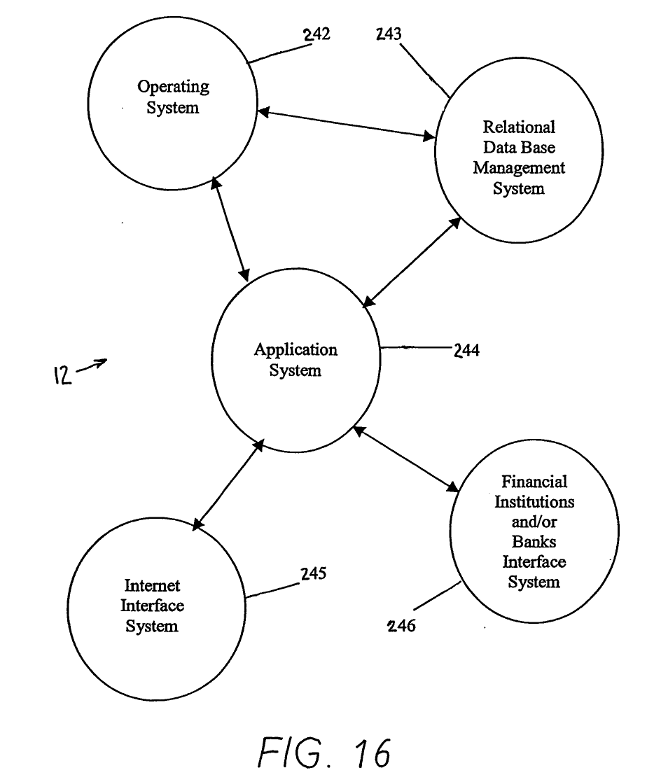

Referring to FIG. 16, the structure of the transaction manager 12 is shown. The transaction manager is a high end computer system running an operating system 242 within which is an application system 244 and a relational database management system 243. The application system 244 and relational database management system 243 both communicate with the operating system 242 and with each other. The application system 244 runs a computer application that controls the operation of the transaction manager. So as to interact with users or merchants of financial institutions. The relational database management system operates a database containing a users transaction manager accounts and merchant accounts.

The application system 244 interacts with merchants and users by the Internet interface system 245. It is noted that if other communication mediums such as public switch telephone networks or cell phone networks 200, 201 are used, the interface system will interface with these networks as well or other interface systems will be provided to interface with these networks. The application system also communicates with financial institution and/or banks interface system 246 which allows communication between the transaction manager 12 and financial institution 18.

Due to transaction identification numbers being single use the user has peace of mind in that they do not have to be concerned with the merchant keeping a copy of the transaction identification number as it will not be useable again. This is unlike a credit card number which may be re-used or potentially fall into the wrong hands.

Modifications and variations may be made to the present invention without departing from the basic inventive concept. Such modifications are intended to fall within the scope of the present invention, the nature of which are to be determined from the foregoing description.

1. A method of conducting an on-line transaction including the steps of: providing a transaction manager; generating a single use transaction request identification; the transaction manager relating the transaction request identification to banking information of a registered user; providing the registered user with the transaction request identification; the registered user requesting to purchase a product or service having a value from a merchant, the purchase request including providing the transaction request identification to the merchant; the merchant sending a payment request to the transaction manager for a fund transfer of the value from the user to the merchant, the payment request including the transaction request identification and the value; the transaction manager checking the validity of the transaction request identification and disabling re-use of the transaction request identification; and if the transaction request identification is valid, sending an EFT request to a financial institution to transfer the value in funds from the user to the merchant, the EFT request including the banking information; checking whether sufficient funds are present in the user's bank account and if sufficient funds are present, the financial institution performing the transfer according to the banking information; and the transaction manager receiving confirmation of the transfer from the financial institution and sending the confirmation to the merchant.

2. A method according to claim 1, wherein the transaction manager generates the transaction request identification.

3. A method according to claim 1, wherein the transaction request identification is a random number.

4. A method according to claim 1, wherein the transaction request identification is generated using a formula.

5. A method according to claim 1, wherein the transaction request identification is generated using a random number and a formula.

6. A method according to claim 1, wherein a combined transaction identification is generated by hatching the transaction manager generated transaction request identification and a user supplied identification code, the combined transaction identification being send in the purchase request to the transaction manager.

7. A method according to claim 6, wherein the merchant is provided with the transaction request identification in the form of the combination transaction identification.

8. A method according to claim 1, wherein the banking information related to the transaction request identification includes a credit card or debit card number, a card expiry date and a cardholder name.

9. A method according to claim 8, wherein the banking information includes a bank account number.

10. A method according to claim 8, wherein the banking information may additionally include bank account type and bank account holder information.

11. A method according to claim 8, wherein registration of the user occurs prior to the generation of the transaction identification.

12. A method according to claim 8, wherein registration of the user entails creation of a transaction manager user account, wherein the transaction manager user account includes a transaction manager account number and the banking information is provided by the user to the transaction manager.

13. A method according to claim 8, wherein the transaction manager confirms the further transaction information with the user's financial institution.

14. A method according to claim 1, wherein registration of the user includes the user providing the transaction manager with the user supplied identification code.

15. A method according to claim 1, wherein the transaction request identification is related to transaction manager user account information thereby linking the transaction request identification to the banking information.

16. A method according to claim 15, wherein the transaction manager information includes a transaction manager account number, and preferably a transaction manager account expiry date, and a transaction manager account password.

17. A method according to claim 15, wherein the transaction manager information further includes a transaction manager account alias.

18. A method according to claim 15, wherein each relationship of a transaction request identification to the banking information further includes a transaction manager account number or transaction account alias, transaction limit, and a transaction limit override password.

19. A method according to claim 1, wherein the registered user is provided with another single use transaction request identification by the transaction manager upon request by the registered user.

20. A method according to claim 1, wherein the merchant is registered with the transaction manager.

21. A method according to claim 20, wherein registration of the merchant entails the transaction manager providing the merchant with a merchant identification.

22. A method according to claim 20, wherein the purchase request sent by the merchant to the transaction manager includes the merchant identification.

23. A method according to claim 1, wherein the purchase request includes providing the merchant with the value of the purchase.

24. A method according to claim 1, wherein the user nominates the purchase item and the merchant provides the purchase value.

25. A method according to claim 1, wherein the transaction manager validates the transaction request identification by checking that the transaction request identification is related to the user's transaction manager account.

26. A method according to claim 25, wherein the transaction manager account password is provided to authenticate the identity of the user providing the transaction request identification.

27. A method according to claim 25, wherein disabling of the use of the transaction request identification is conducted by removing the relationship between the transaction request identification and the user's transaction manager account number.

28. A method according to claim 25, wherein the transaction request identification is deleted from the user's transaction manager account information.

29. A method according to claim 25, wherein disabling use of the transaction request identification includes the step of adding the transaction request identification to a spent list, the spent list being used to ensure a transaction request identification is not reused.

30. A method according to claim 25, wherein the EFT request to the financial institution is conducted using the credit card or bank account details, the transfer amount (value of the transfer) and the merchant account details sent to the financial institution to transfer the funds according to a standard electronic fund transfer system.

31. A method according to claim 1, wherein the financial institution sends an insufficient funds reply if sufficient funds are not present, whereupon the transaction manager sends an insufficient funds reply to the merchant.

32. A method according to claim 1, wherein the confirmation of the transfer sent from the financial institution to the transfer manager is the same as the confirmation message sent from the transaction manager to the merchant.

33. A method according to claim 1, wherein the transaction manager creates a different confirmation message for the merchant.

34. A method according to claim 1, wherein in one embodiment the step of disabling re-use of the transaction request identification includes the formula for generating the single use transaction request identification including an increment in the next transaction identification request issued.

35. A method according to claim 34, wherein the method of generating the transaction identification includes providing a check sum digit or character in the transaction request identification.

36. A method according to claim 34, wherein the transaction request identification is a number.

37. A method according to claim 1, wherein confirmation of transfer of funds is sent from the merchant or transaction manager to the user.

38. A method according to claim 37, wherein this confirmation is sent in the form of an e-mail message.

39. A method according to claim 1, wherein the transaction request identification is issued to the user in an on-line environment, such as via the Internet.

40. A method according to claim 1, wherein the transaction request identification is provided to the user by a telephone interface system.

41. A method according to claim 1, wherein the transaction identification is issued to the user by sending the transaction identification to a portable storage device held by the user.

42. A method according to claim 41, wherein the user can activate transfer of the transaction request identification from the portable device to the merchant.

43. A method according to claim 41, wherein the portable storage device can store a plurality of transaction request identifications.

44. A method according to claim 1, wherein a plurality of transaction request identifications may be provided to the user.

45. A method according to claim 1, wherein the transaction manager manages a plurality of registered users each having a plurality of transaction request identifications available for use in making a purchase or purchases.

46. A method according to claim 1, wherein the transaction manager registers a plurality of merchants.

47. A method according to claim 1, wherein the transaction manager can conduct electronic transfers between a plurality of financial institutions.

48. A method of conducting an on-line transaction including the steps of: providing a transaction manager; generating a single use transaction request identification; the transaction manager relating the transaction request identification to banking information of a registered user; providing the registered user with a transaction request identification; the registered user requesting to transfer an amount from a user account to another account, the transfer request including providing the transaction request identification and amount to the transaction manager; the transaction manager checking the validity of the transaction request identification and disabling re-use of the transaction request identification; if the transaction identification is valid, sending an EFT request to a financial institution to transfer the amount of funds from the user's account to the other account, the EFT request including the banking information; checking whether sufficient funds are in the user's bank account and if sufficient funds are present, the financial institution performing the transfer according to the banking information; and the transaction manager receiving confirmation of the transfer from the financial institution and sending the confirmation to the user.

49. A system for conducting an on-line transaction including: a transaction manager comprising; means for registering a user; means for registering a merchant; means for generating a single use transaction request identification; means for providing the registered user with a transaction request identification; means arranged to relate the transaction request identification to banking information of a registered user; means for receiving a payment request, the payment request including the transaction request identification, the value to be transferred and an identification of a receiving party; means for checking the validity of the transaction request identification and disabling re-use of the transaction request identification; means for sending an EFT request to a financial institution to transfer the value in funds from the user to the receiving party, if the transaction request identification is valid, the EFT request including the banking information; means for receiving confirmation of the transfer from the financial institution and sending the confirmation to the user AND/OR the other party; and means for the user to request transfer of the value to be transferred to the other party and providing the transaction request identification to the transaction manager.

50. A transaction manager for conducting an online transaction, comprising: means for registering a user and receiving banking information from the user; means for registering a merchant; means for receiving a request from a user for a single use transaction request identification for making a purchase; means for generating the single use transaction request identification; means for checking the validity of the user, providing the user with the transaction request identification to the banking information of the user if the user is valid, and relating the transaction request identification; means for receiving the transaction request identifier and a value of a purchase from the merchant in a purchase report, the transaction request identification having been provided by the user to the merchant in the course of requesting a transaction for the purchase; sending an EFT request to a financial institution to transfer the value in funds from the user to the merchant, the EFT request including the banking information, if the transaction request identification is valid; and means for validating the transaction request identification, disabling re-use of the transaction request identification and means for providing the merchant with a unique transaction acceptance identifier if sufficient funds are present for the transfer to occur.

51. A method according to claim 1, wherein the transaction request identification is a string of characters.

52. A method according to claim 1, wherein the transaction request identification is a randomly generated string of characters.

53. A method of conducting an on-line financial transaction comprising the steps of:
registering a user with a transaction manager;
providing the user with an identification code;
identifying the user to the transaction manager by the user providing the identification code to the transaction manager for verification, and when verified providing the user with a single use transaction code;
requesting a financial transaction including the user providing the transaction code;
verifying the identity of the user from the transaction code, and when verified authorizing the financial transaction.

54. A method according to claim 53, wherein the identification code comprises a login code and a password.

55. A method according to claim 53, wherein the identification code is associated with banking information of the user, which is stored by the transaction manager.

56. A method according to claim 53, wherein the transaction code is generated by the transaction manger.

57. A method according to claim 53, wherein the transaction code is related to the identification code.

58. A method according to claim 53, wherein the user requests the transaction from a third party.

59. A method according to claim 58, wherein the third party is a merchant.

60. A method accordingly to claim 59, wherein the transaction is for the purchase of a good or service from the merchant.

61. A method according to claim 58, wherein the third party is a financial institution.

62. A method according to claim 58, wherein the user provides the third party with the transaction code as a part of the request.

63. A method according to claim 58, wherein the transaction code is provided to the transaction manager by the third party.

64. A method according to claim 53, wherein the value of the financial transaction is provided to the transaction manager by the third party.

65. A method according to claim 53, wherein if the financial transaction is authorised an Electronic Funds Transfer (EFT) request is sent to a financial institution according to the banking information stored by the transaction manger.

66. A method according to claim 65, wherein the EFT request is for the transfer of the value of the transaction from the user according to the user's banking information to the third party.

67. A method according to claim 53, wherein a check is performed prior to authorizing the transaction as to whether the transaction is allowed to proceed.

68. A method according to claim 67, wherein the transaction is allowed to proceed if sufficient funds are available to cover the amount of the transaction.

69. A method according to claim 65, wherein a check is performed as part of the EFT as to whether there are sufficient funds available to perform the EFT.

70. A method according to claim 69, wherein the manager is notified of the success of the EFT.

71. A method according to claim 58, wherein the transaction manager provides a confirmation to the third party of success of the financial transaction.
